(19) United States
(12) Patent Application Publication
(10) Pub. No.: US 2008/0258540 A1
(43) Pub. Date: Oct. 23, 2008

(54) SWIVEL YOKE FOR SUPERMARKET MOBILE MATERIAL HANDLING EQUIPMENT

(76) Inventors: E. David Hicks, Mansfield, TX (US); Jimmy L. Hicks, Arlington, TX (US)

Correspondence Address: DECKER, JONES, MCMACKIN, MCCLANE, HALL &;BATES, P.C., BURNETT PLAZA 2000, 801 CHERRY STREET, UNIT #46, FORT WORTH, TX, 76102-6836, US

(21) Appl. No.: 11/877,459

(22) Filed: Oct. 23, 2007

Related U.S. Application Data
(60) Provisional application No. 60/853,854, filed on Oct. 24, 2006.

(51) Int. Cl. B60B 37/00; B60B 33/00

(52) U.S. Cl. 301/111.01; 16/21

(57) ABSTRACT

A swivel yoke assembly is used for supermarket mobile material handling equipment. The yoke assembly includes a yoke, a bearing and a cage. The yoke can be made from low grade steel. The swivel bearing can withstand heavy cart loads and has an outer race and a split inner race. The races cover a large part of the balls, so as to provide support. Also, the balls are tightly packed into the bearing leaving little total space between the balls, again to provide support for the load. The outer race is clamped to the yoke by the cage. The cage is secured to the yoke by staking, wherein tabs are inserted into slots in the yoke and the tabs are formed with double shoulders. A cover is provided to protect the bearing from the environment.

This application claims the benefit of U.S. provisional application Ser. No. 60/853,854, filed Oct. 24, 2006.

### FIELD OF THE INVENTION

The present invention relates to swivel wheels and casters for supermarket mobile material handling equipment, such as shopping carts.

### BACKGROUND OF THE INVENTION

Shopping carts were introduced to the mass market in the 1940's and continue to be useful equipment in retail and wholesale stores. A shopping cart has a metal or plastic basket or receptacle for receiving goods. A shopping cart is one type of supermarket mobile material handling equipment. Other types include a cart having a low flat bed or platform.

In a shopping cart, the basket is mounted on front and rear casters or wheels. The front casters are capable of swiveling 360 degrees, while the back casters are typically rigid and cannot swivel. Having front swivel casters allows the user, who typically pushes the cart from the rear, to better steer the cart. Some shopping carts have all four wheels as swivel casters.

The swivel casters utilize a yoke for straddling the wheel. In the prior art, the yoke has a top plate, which has a double ball race, with 18 balls in a top race (located above the yoke top plate) and 18 balls in a bottom race (located below the yoke top plate). A kingpin extends up from the bearing and attaches to the cart. The bearing allows the yoke to swivel 360 degrees.

For many years, this prior art swivel caster has performed satisfactorily.

Until the late 1980's, shopping carts weighed about 40 to 50 pounds empty. The introduction of large, warehouse type stores has lead to an increase in the size and weight of shopping carts. Shopping carts can now weigh on the order of 55-70 pounds, empty, which carts can carry heavy loads. The heavy carts and loads have caused problems with the double ball race breaking on the front swivel casters. The yokes are made of soft, inexpensive steel; the balls wear into the steel, degrading the races and increasing friction, making cart steering difficult.

In addition, maintenance practices for shopping carts changed. Stores typically clean shopping carts with pressure washers. Within the last decade or so, the pressure on pressure washers used by stores has roughly doubled to over 2,000 psi. As a result, bearing seals are easily broken or compromised by the higher wash pressures, resulting in the bearings operating “dry”, with little or no grease. Rust in the bearings and on the yoke itself has become a problem. The rust is unsightly and adds to the friction of the swivel caster.

The shopping cart business is difficult. The customers are the stores who in turn retail and wholesale goods to other customers. Shopping cart customers do not accept price increases without some reduction in maintenance costs. As the retail industry has consolidated, with many “big box” stores, unilaterally enforcing a price increase on to the customers is difficult.

In the past, bearing components were heat treated in order to harden the components and increase wearability. Such hardening, which was relatively lost cost, was accepted by customers and improved the swivel casters.

In the last few years, stores have adopted even larger shopping carts, with huge weight increases in the carts and in the contents. These heavier carts have added stress to the casters, and have reduced the life and reliability of the casters.

We developed an all plastic yoke with a metal precision bearing held in place by a snap ring. A precision bearing is a high weight bearing made with hardened components, milled to close tolerances and sealed. Precision bearings are expensive and add to the overall cost of a caster. The bearing and snap ring were located inside of an injection mold so the yoke plastic was molded around the bearing. Such a yoke solved the problems of rust (plastic does not rust) and wear (the precision bearing handled the stresses). However, the yoke was very expensive compared to prior art metal yokes. Consequently, the yoke failed commercially; customers were unwilling to accept the price increase.

What is needed is a yoke and a swivel caster that has increased wearability so as to handle the large shopping cart loads, provide low friction, minimizes rust and is of a price that is acceptable to the industry.

### SUMMARY OF THE INVENTION

The present invention provides a swivel yoke assembly for supermarket material handling equipment, comprising a yoke. The yoke has a top plate with an kingpin opening therethrough and with cage tab openings spaced about the kingpin opening. The yoke also has legs extending from the top plate, the legs being spaced apart from each other and being structured and arranged to receive a wheel and an axle. A bearing has inner and outer races and balls located in the races, the inner and outer races covering at least 60% of the balls. The balls have spacing therebetween; the total spacing between the balls being less than one diameter of an individual one of the balls. The outer bearing on the top plate. A kingpin is located inside of the inner races of the bearing. The inner races of the bearing is secured to the kingpin by staking. A cage covers the bearing, with the top plate interposed between the cage and the legs. The cage having tabs that are received by the tab openings in the top plate, the tabs forming double shoulder stakes on the leg side of the top plate.

In accordance with one aspect of the invention, the top plate has a fore-and-aft axis, the tab openings being offset from the fore- and aft axis.

In accordance with another aspect of the invention, the cage tabs are located around the circumference of the bearing. Each tab has an inner shoulder on an inside of the tab and an outer shoulder on an outside of the tab.

In accordance with another aspect of the invention, the bearing outer race is clamped between the cage and the top plate.

In accordance with another aspect of the invention, the inner race is split into an upper portion and a lower portion.

In accordance with another aspect of the invention, the inner and outer races each have a notch for receiving the balls into the inner and outer races.

In accordance with another aspect of the invention, the yoke is heat treated.

In accordance with another aspect of the invention, a sleeve is located around a circumference of the cage and a shield is in an annulus between the cage and the kingpin, the sleeve and the shield protecting the bearing from the environment.

In accordance with another aspect of the invention, the top plate has a fore-and-aft axis, the tab openings being offset from the fore- and aft axis. The cage tabs are located around the circumference of the bearing, each tab having an inner shoulder on an inside of the tab and an outer shoulder on an outside of the tab. The outer race is clamped between the cage and the top plate.

In accordance with another aspect of the invention, the top plate has a fore-and-aft axis, the top plate further comprising a rib located on the fore- and aft axis.

In accordance with another aspect of the invention, the cage tabs are located around the circumference of the bearing, each tab having an inner shoulder on an inside of the tab and an outer shoulder on an outside of the tab. The outer race is clamped between the cage and the top plate.

In accordance with another aspect of the invention, there is provided a cover comprising a cup-shaped portion for fitting over the bearing and a flange that extends out from the cup-shaped portion, the flange covering the rib.

The present invention also provides a swivel yoke assembly for supermarket material handling equipment, comprising a yoke having a top plate with cage tab openings spaced about the kingpin opening. The yoke also having legs extending from the top plate, the legs being spaced apart from each other and being structured and arranged to receive a wheel and an axle. A bearing having inner and outer races and balls located in the races, the inner and outer races covering at least 60% of the balls, the balls having spacing therebetween, the total spacing between the balls being less than one diameter of an individual one of the balls, the outer bearing on the top plate. A kingpin extending from the bearing. A cage covers the bearing, with the top plate interposed between the cage and the legs, the cage having tabs that are received by the tab openings in the top plate, the tabs forming double shoulder stakes on the leg side of the top plate.

In accordance with another aspect of the invention, the inner bearing is integral to the kingpin.

In accordance with another aspect of the invention, the kingpin lies wholly on one side of the top plate.

In accordance with another aspect of the invention, the inner bearing is integral to the kingpin, the kingpin lies wholly on one side of the top plate and the kingpin is made of hardened steel.

### BRIEF DESCRIPTION OF THE DRAWINGS

FIG. 1 is an exploded view of a yoke assembly of the present invention, in accordance with a preferred embodiment.

FIG. 2 is a cross-sectional view of the yoke assembly taken along lines II-II of FIG. 1.

FIG. 3 is an exploded view of the kingpin and the inner race portions.

FIG. 4 is a top view of the assembled bearing and kingpin.

FIG. 5 is a cross-sectional view of the bearing and kingpin.

FIG. 6 is a bottom view of the yoke, shown with cage tabs inserted before staking.

FIG. 7 is a bottom view of the yoke, shown after the staking of the cage tabs.

FIG. 8 is an isometric view of a yoke assembly in accordance with another embodiment.

FIG. 9 is a cross-sectional view, taken through lines IX-IX of FIG. 8.

FIG. 10 is an isometric view of the yoke of FIG. 8.

FIG. 11 is an exploded isometric view of a yoke assembly in accordance with another embodiment.

FIG. 12 is a cross-sectional view, taken along lines XII-XII of FIG. 11.

FIG. 13 is a top view of the bearing, shown without the balls.

FIG. 14 is a top view of the bearing, shown with balls.

FIG. 15 is an exploded view of the yoke assembly, in accordance with another embodiment.

FIG. 16 is a perspective view of the assembled yoke assembly of FIG. 15.

FIG. 17 is a cross-sectional view of the yoke assembly, taken through lines XVII-XVII of FIG. 16.

### DESCRIPTION OF THE PREFERRED EMBODIMENTS

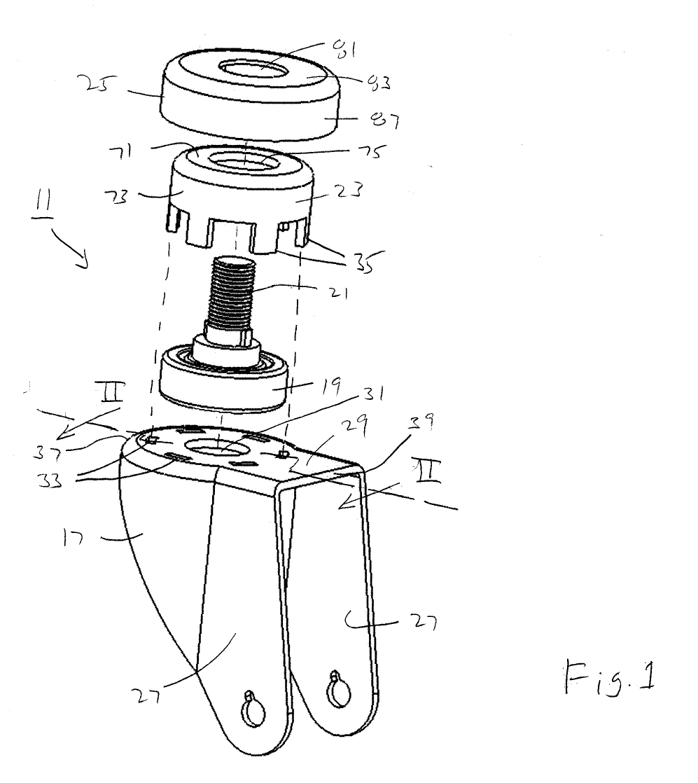

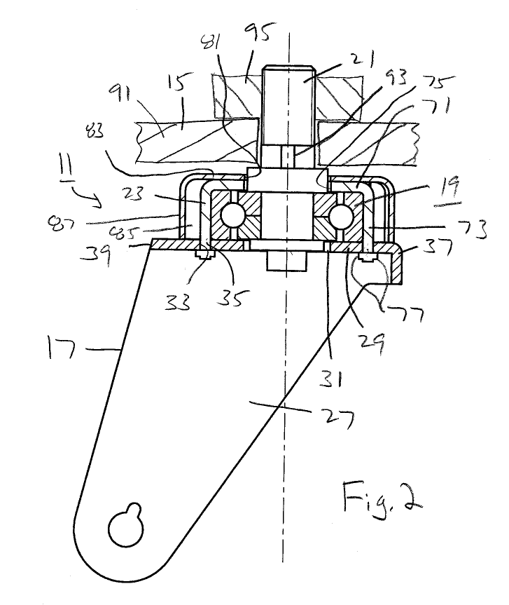

Referring to FIGS. 1 and 2, the swivel yoke assembly 11 of the present invention is used on supermarket mobile material handling equipment 15. Supermarket mobile material handling equipment include shopping carts, which have a basket or receptacle for receiving goods. Supermarket mobile material handling equipment typically also include flat bed carts which have a low bed for hauling large, bulky items. Some types of this equipment, such as shopping carts, have handles to allow a user to push the cart. The carts are mounted on casters for ease of rolling. The front casters swivel for ease of steering. The carts can have the rear casters either fixed or swiveled.

Shopping carts have particular requirements not found elsewhere. Shopping carts are large and heavy, weighing 55 to 70 pounds or more (when empty) and are capable of carrying a heavy load of merchandise. A typical load may be several hundred pounds. The yoke bearing is horizontally oriented (so as to rotate about a vertical axis) and bears this load on the sides of the bearing. This is different than the wheel bearing on the cart, which wheel bearing is vertically oriented (so as to rotate about a horizontal axis). The stresses are distributed throughout the yoke wheel bearings differently. With a wheel bearing, the stresses are directed into the races, where in a yoke bearing, the stresses are directed parallel to the axis. In the prior art double ball race bearing, the races are above and below the balls. Consequently, the stresses are directed into the races, much like the wheel bearing. However, using a bearing more like a wheel bearing for the yoke bearing means that the stresses are now directed into the gap between the races. Such an arrangement is shown by Su, U.S. Pat. No. 6,463,624. This is a more difficult design to work with as the bearings are subject to fail under the loads encountered.

The carts are pushed along by humans and consequently travel at low speeds (no more than 3 to 4 miles per hour). The swivel casters on the front are also low speed or low rpm. The swivel that occurs for steering is only a few miles per hour.

Thus, the swivel casters used in shopping carts must withstand heavy loads and operate at low speeds. Swivel casters must also be inexpensive. It is easy to make a swivel caster that will withstand the load requirements by using the most durable materials with high tolerances. Such a swivel caster would be expensive; few retailers, if any, would buy it. Retailers (including wholesalers) derive no income from shopping carts and look to reduce their costs associated with the carts, including purchases and maintenance. Thus, the swivel casters used on shopping carts must be inexpensive.

To produce an inexpensive swivel caster, the material cost must be low and the assembly cost must be low. The swivel yoke assembly of the present invention provides an inexpensive swivel caster that can withstand the heavy cart loads to provide low friction steering. The swivel yoke assembly of the present invention also minimizes maintenance and provides long service life by minimizing the occurrence of rust.

The swivel yoke assembly 11, when mounted to a wheel, provides a swivel caster. Referring again to FIGS. 1 and 2, the swivel yoke assembly includes a yoke 17, a cart yoke bearing 19, a kingpin 21, a cage 23 and a cover 25. The yoke 17 is designed so that it can be made from low grade steel, is capable of withstanding the heavy cart loads, and in some embodiments can be coated to minimize rust. The cart yoke bearing 19 is designed to withstand heavy cart loads, is easy to assemble and needs no grease seals. The cage 23 couples the cart yoke bearing 19 to the yoke 11 in a manner that is inexpensive to manufacture, is capable of withstanding heavy cart loads and serves to protect the cart yoke bearing 19. The cover 25 also serves to protect the cart yoke bearing 19. Each of these components will now be discussed.

The yoke 11 has legs 27 connected together by a top plate 29. The yoke legs 27 are spaced apart from each so as to receive a wheel and axle (not shown). The top plate 29 has an opening 31 for receiving a portion of the kingpin 21. The opening 31 for the kingpin 21 is vertically offset from the wheel axle, which axle passes between the legs 27. This offset allows the wheel to trail the kingpin when the wheel is rolling. The offset also means that the load borne by the bearing is not evenly distributed around the bearing. A set of slots 33, or cage tab openings, surround the kingpin opening 31. The slots receive tabs 35 from the cage 23.

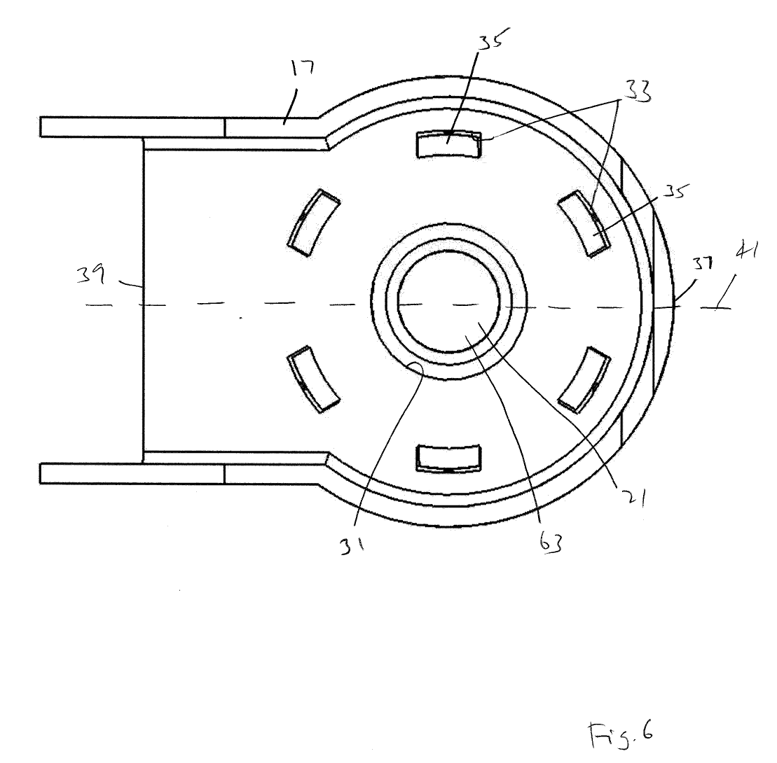

The slots 33 are arranged in a particular manner. As shown in FIGS. 1 and 6, the yoke 17 has a front 37 which is the direction of the yoke when the cart is pushed forward, and a rear 39. Yokes receive impacts primarily along a front-to-rear axis 41. For example, a cart can be run into a curb or another obstacle. The slots 33 do not lie along the front-to-rear axis 41. The slots 33 are arranged away from, or are offset from, this front-to-rear axis 41, so as to maintain structural strength of the yoke top end plate 29. (In FIG. 2, the cross-section is taken, not along the front-to-rear axis 41, but through the slots 33 to illustrate tab staking.)

The yoke 17 is made of steel plate that is cut and then bent, such as by a press, into shape. The opening 31 and slots 33 are typically punched before the part is bent. The yoke is made from low cost soft steel, such as 1008. In addition, the yoke 17 is heat treated, or carburized, to provide structural strength.

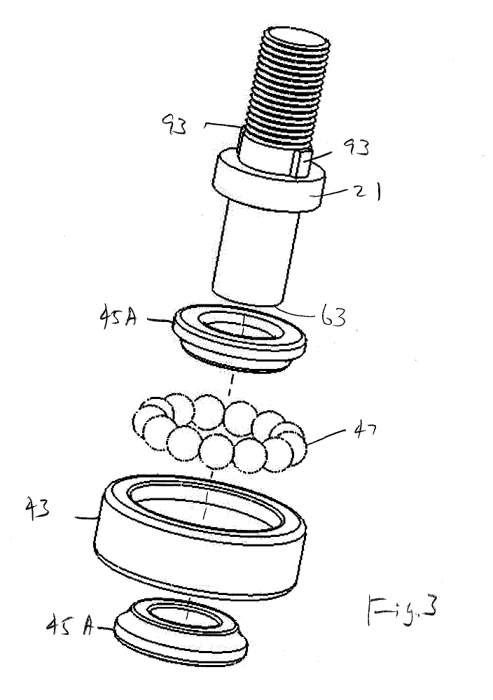

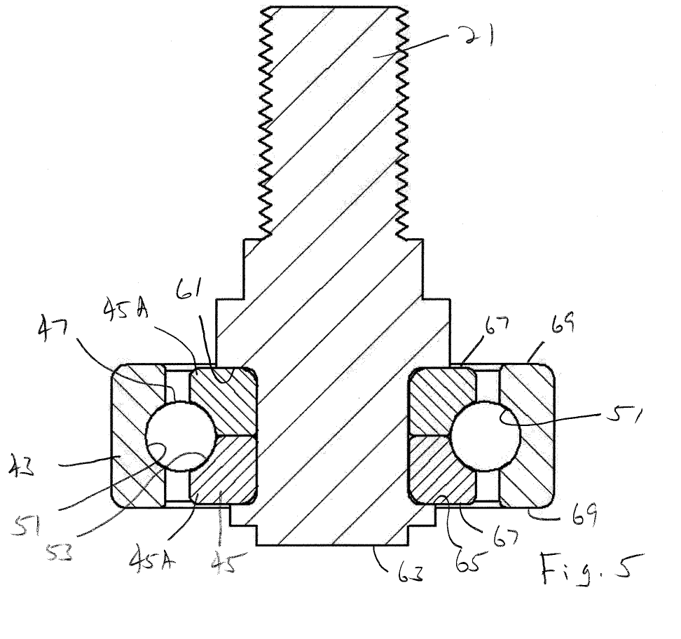

The cart yoke bearing 19 is designed for the particular application of supermarket mobile material handling carts and in particular for shopping carts. The cart yoke bearing 19 has the durability and reliability of expensive precision bearings, but at a much lower cost. The cart yoke bearing 19 is capable of withstanding heavy cart loads for a number of years yet is inexpensive to manufacture. Referring to FIGS. 3 and 5, the cart yoke bearing has an outer ring 43 and an inner ring 45 and balls 47. The outer ring 43 has an outside race 51. The inner ring 45 has an inner race 53. The bearing is oriented so as rotate about the vertical kingpin. This is a different orientation than such bearings are used for. Such bearings are used for the wheel and rotate about a horizontal axle, with the load being applied fully yo the races. Here, the load is applied in a direction that is between the races (see FIG. 2). Each race 51, 53 has a certain depth, so as to encompass a considerable portion, or diameter, of each ball 47, thereby better distributing loads. The races 51, 53 or grooves cover 60%-95% of the balls. For example, when the bearing is viewed in transverse cross-section, as shown in FIG. 5, about 60%-95% of the diameter of a ball, is located within the races of the bearing. For example, for a 6 mm diameter ball, the gap between the rings 43, 45 is only 1.75 mm. Covering such a large amount of the balls reduces the rocking of the king pin 21.

The inner ring 45 is made of two portions 45A so as to effectively split the inner race 53. Splitting or dividing the inner race allows for ease of assembly and manufacturing. The inner race portions 45A are made from tubing. Inner races are typically made from bar stock. A length of tubing is pressed into the desired shape. The use of tubing reduces costs of manufacturing by using less expensive stock and reducing milling operations. Also use of a split inner ring eliminates costly grooving of the outer and inner races that permit the balls to be loaded. The inner and outer races are heat treated and the race surfaces are finished ground.

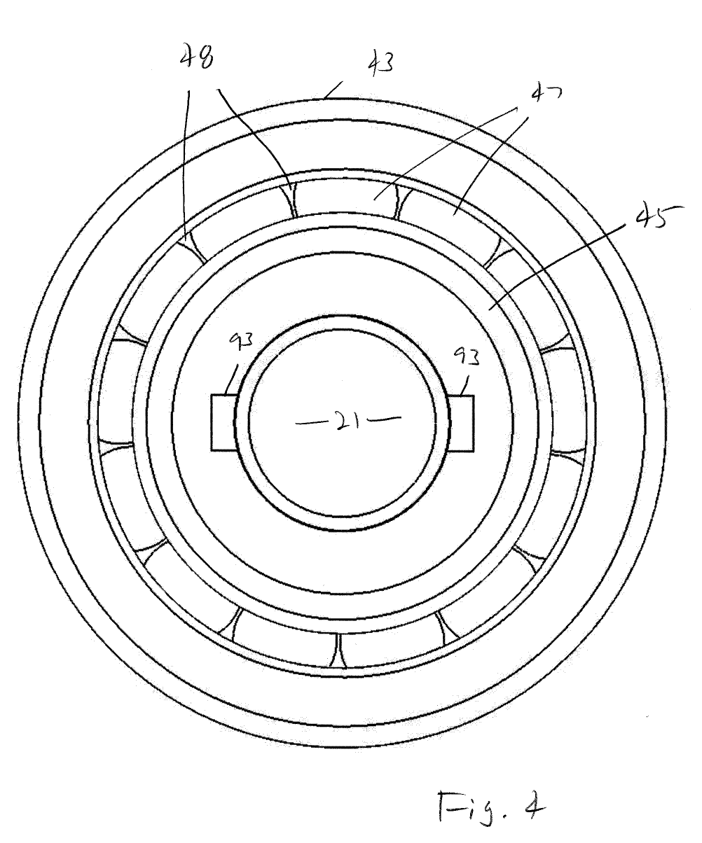

The cart yoke bearing 19 is assembled by locating the lower portion of the inner ring 45A within the outer ring 43. Balls 47 are then placed into the races from the top side. No retainer for the balls is used. Instead, a relatively large number of balls are placed into the bearing so as to better distribute the load. The number of balls 47 is such that the total spacing 48 between the balls is about ¼-1.0 of the diameter of a ball 47. (FIG. 4 illustrates the tight fit of the balls, although the gaps between the balls are exaggerated in FIG. 4.) In the preferred embodiment, the number of balls 47 used in the bearing is 13 with a total spacing between the balls of ½ of the diameter of a ball 41. This relatively tight spacing also insures that the balls will not exit the bearing once fully assembled.

When all of the balls have been placed into the open bearing, grease is put into the bearing and the bearing is then closed by inserting the top inner ring portion 45A. Alternatively, grease can be put into the bearing after the bearing has been assembled.

The two inner race portions 45A are coupled together by the kingpin 21. The kingpin 21 has a shoulder 61 (see FIG. 5), which contacts the top side of the inner race 45. The kingpin extends through the two inner race portions 45A. The lower end 63 of the kingpin is staked so as to form a lower shoulder 65 that contacts the bottom of the inner ring 45. During the staking operation, material is moved from the lower end of the kingpin toward the inner ring and radially out. Staking of the kingpin clamps the two inner ring portions 45A together and prevents one portion from moving with respect to the other portion. The staking will be discussed in more detail below.

After the kingpin 21 is staked, grease is added to the cart yoke bearing through the space or gap between the inner and outer rings 43, 45. The cart yoke bearing does not have grease seals.

The top and bottom surfaces 67 of the inner ring 45 are recessed with respect to the top and bottom surfaces 69 of the outer ring 43. This allows the cart yoke bearing 19 to be coupled to the yoke 17 by the outer ring 43, while allowing the inner ring 45 to rotate with respect to the outer ring.

The cart yoke bearing 19 is coupled to the yoke 17 by the cage 23 (see FIGS. 1 and 2). The cage 23, which is made of metal, is shaped like an inverted, or upside down, cup. The cage thus has a top wall 71 and a cylindrical side wall 73. The top wall has an opening 75 for receiving the kingpin. The cage 23 side wall has tabs 35 depending therefrom, one tab for each slot 33 in the yoke 17.

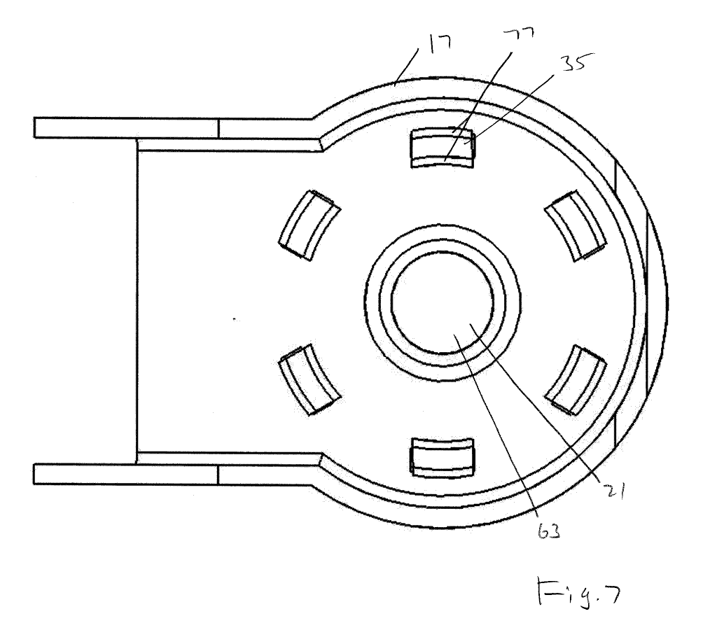

During assembly, the bearing 19 is located within the cage 23. In the preferred embodiment, the outer ring 43 is pressed into the cage with an interference fit. The kingpin 21 extends through the cage top wall opening 75. Next, the cage 23 is assembled onto the yoke 17 such that the tabs 35 extend through the slots 33 and the bottom end of the kingpin 21 extends through the yoke opening 31. Pressure is applied to force the cage 23 and bearing 19 into the yoke 17. While the cage and bearing are being pressed into the yoke, the tabs 35 are staked in such a manner so as to maintain the tight fit of the cage and bearing against the yoke. The tabs 35 are staked by applying a die to the underside of the yoke, against the tabs. The die deforms each tab end so as to form a shoulder 77 on each side of the tab free end, as shown in FIGS. 2 and 7. Material from the free end of each tab is moved toward the yoke, where it flares into a shoulder. The staking forms an inside shoulder, which is on the side of the tab facing the king pin, and an outside shoulder, which is on the side of the tab facing away from the king pin. Thus, the cage 23 and bearing 19 are firmly and tightly coupled to the yoke 17. The inner ring 45 and kingpin 21 can rotate with respect to the yoke 17.

This type of staking, wherein the tabs 35 form a double shoulder 77, or a shoulder on each side of the tab, is a rigorous structure, capable of withstanding the impacts and stresses of typical cart usage. The outer ring 43 of the bearing is clamped between the cage and the yoke. Previous attempts at staking have bent the tabs. Mere bending of the tabs does not satisfactorily couple the cage to the yoke, as the stresses of cart usage work the tabs loose and cause separation of the cage from the yoke. When there is separation between the yoke and the cage, the bearing is no longer held firmly in place against the yoke and premature failure can occur with typical cart usage.

Referring to FIGS. 1 and 2, the plastic cover 25 is cup shaped, having an opening 81 in its top wall 83 for the kingpin 21. The interior of the cover 25 has ribs 85 that extend radially inward from the cylindrical side wall 87. When the cover 25 is placed onto the cage 23, the kingpin 21 extends out through the opening 81 and the ribs 85 engage the cage in an interference fit. The cover provides environmental protection and also provides an aesthetic look.

The top end of the kingpin 21 is threaded. The top end of the kingpin is inserted through an opening in a yoke plate 91 of a cart 15 (see FIG. 2). Keys 93 on the kingpin engage keyways on the yoke plate. A nut 95 is used to couple the kingpin to the yoke plate. The kingpin 21 is made from cold formed wire, of a high grade steel. The kingpin is zinc plated.

The kingpin 21 and inner ring 45 are stationary with respect to the cart, while the outer ring 43, cage 23, cover 25 and yoke 17 can swivel with respect to the cart.

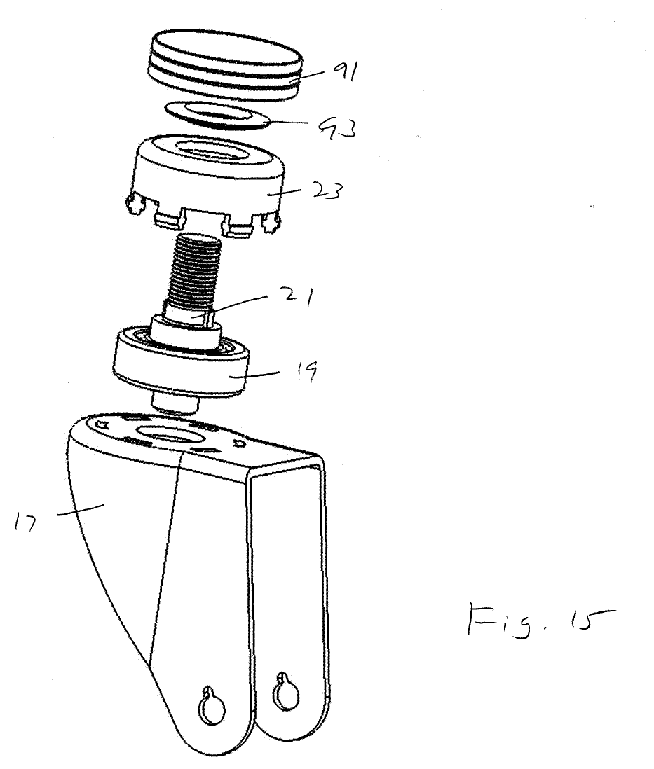

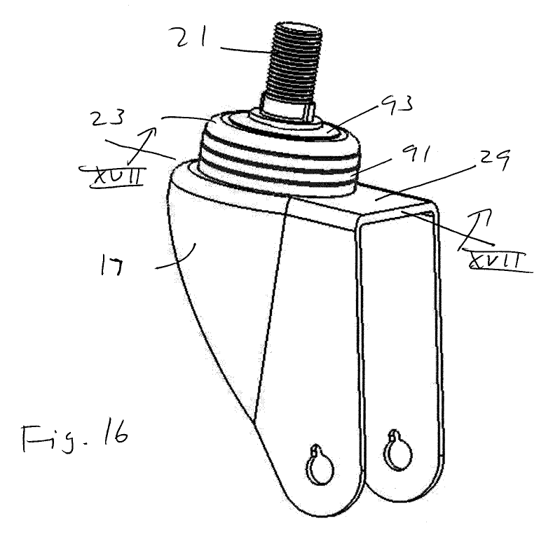

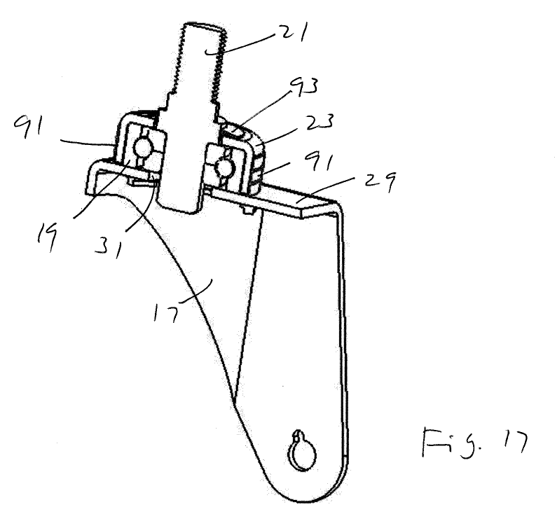

FIGS. 15-17 show the yoke assembly in accordance with another embodiment. The embodiment is the same as in FIGS. 1 and 2, with the exception of the cover. No cover is provided. Instead, protection of the bearing is provided by a sleeve and a shield, in combination with the cage. The plastic sleeve 91 is located around the circumference of the cage; there is an interference fit between the sleeve and the cage 21. The sleeve 91 contacts the top plate 29 of the yoke. The plastic shield 93 is located between the cage and the king pin, at the top of the cage. The shield is provided with a lip that is received in the gap between the cage and the king pin. The sleeve minimizes water, dirt, etc. from entering the bearing between the cage and the top plate, while the shield closes off the gap between the kingpin and the cage.

The yoke 17, the cage 23 and the cover 25 (or alternatively, the sleeve 91 and the shield 93) provide protection for the cart yoke bearing 19, thereby eliminating the need for grease seals. This produces a savings in cost. The gaps between the inner and outer rings, which are where grease seals would typically be located, are protected, on the bottom by the yoke 17, and on the top by the cage 23 and cover 25 (or alternatively, the sleeve 91 and the shield 93). Maintenance procedures, such as using higher pressure spray washers to inject water into the swivel casters, would typically not drive the grease out of the cart yoke bearing 19.

The cart yoke bearing 19 is capable of sustaining high loads. When the cart is at rest, the cart loads, which include both the cart weight and goods loaded onto the cart, is borne by the kingpin upper shoulder 61 and transferred to the inner ring 45 of the cart yoke bearing 19. The inner ring 45 transfers the weight to the balls 47. The balls 47 in turn transfer the weight to the outer ring 43, which then bears on the yoke 17. The yoke of course bears on the wheel axle, which in turn bears on the wheel. Even if the cart yoke bearing 19 loses its grease and operates “dry” or without grease, the bearing will still operate satisfactorily.

The cart yoke bearing 19 uses a large number of balls 47 to better distribute the weight. In addition, the deep races of the inner and outer rings 43, 45 allow the balls 47 to bear on more surface area of the ring races 51, 53, to better transfer the weight over large surface areas.

The front swivel casters on a supermarket mobile material handling equipment cart frequently experience impacts, such as when the cart is run into a curb. Such impacts impart severe rotational moments to the cart wheel bearing 19, where, for example, the front of the bearing is compressed and the back of the bearing is not. The large number of balls 47 and deep races 51, 53 serve to distribute the loads caused by impacts. Also, the particular type of staking 77 of the cage tabs 35 to the yoke serves to securely couple the cage so as to prevent the cage from working loose of the yoke. The yoke 17 itself is designed to withstand such impacts as the openings 33 in the top plate are not on the front-to-rear axis 41 that bears the impact. Instead, the openings 33 are located away from the axis 41.

The cart yoke bearing 19 with its split inner ring 45 may have a slight lip or mismatch in the inner race 53 at the junction of the two inner ring portions 45A. This lip occurs because one inner portion is laterally offset from the other inner ring portion. Because the cart yoke bearing 19 is used mostly for weight transfer from the cart to the yoke and because the bearing undergoes only small rotational movements, any such lip does not adversely affect performance.

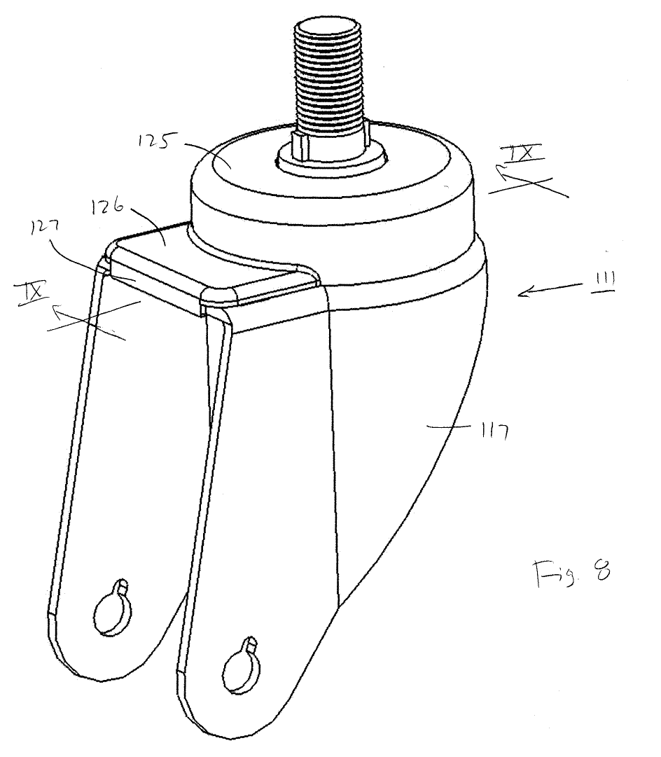

FIGS. 8-10 show the yoke assembly 111 in accordance with another embodiment. The yoke assembly 111 of FIGS. 8-10 is substantially similar to the yoke assembly 11 of FIGS. 1-7, with several exceptions.

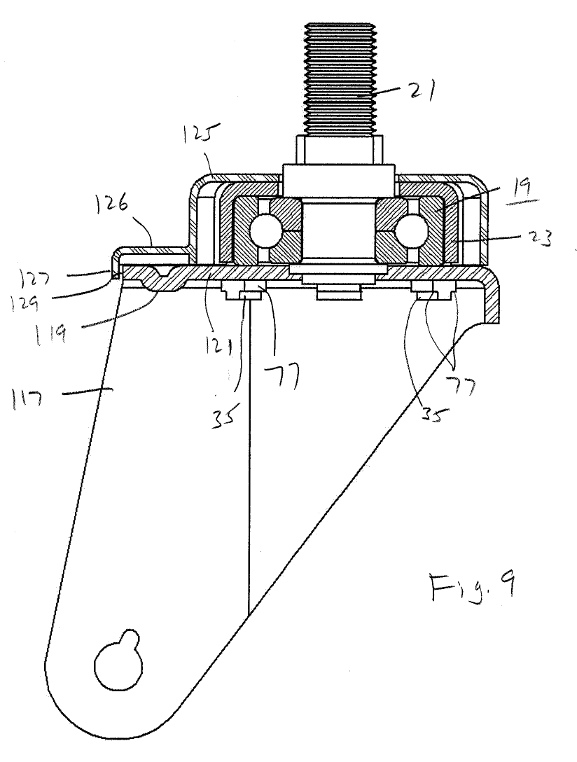

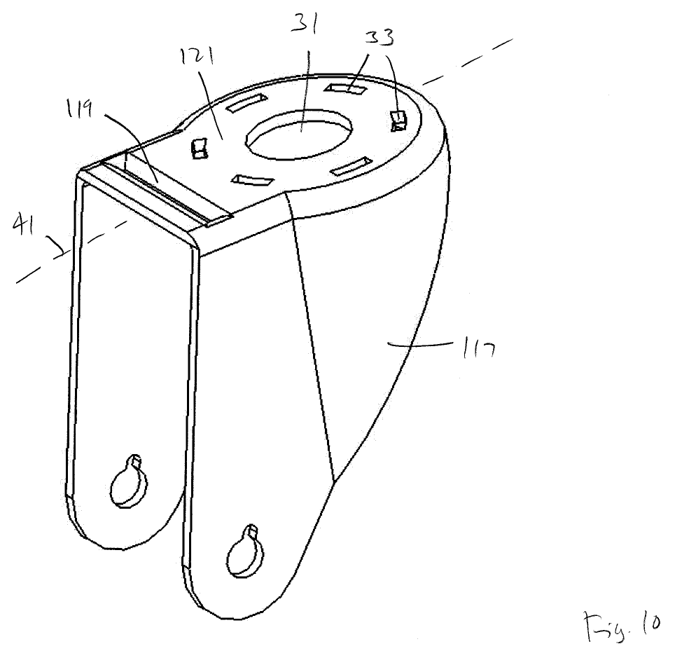

In order to reduce the overall cost, and allow for better environmental protection, the yoke 117 is not heat treated. Because the yoke 117 is not heat treated, the steel is relatively softer than the yoke 17 steel in the embodiment of FIGS. 1-7. A rib 119 is provided on the top plate 121 of the yoke (see FIGS. 9 and 10). The rib 119 is transverse to the front-to-rear axis 41. The rib protrudes downwardly from the bottom of the top plate 121. The rib 119 is pressed into the steel.

The cover 125 has been modified to add a flange 126 that extends over the rear portion of the yoke top plate 121. The cover 125 has a lip 127 that extends over and covers the rear edge 129 of the top plate 121. The cover 125 thus covers the rib 119, preventing foreign material from accumulating therein.

The yoke 117 can be powder coated in order to minimize rusting. Because the yoke has not been heat treated, it can be powder coated. Powder coating requires a relatively soft steel. Heat treated steel typically cannot be powder coated.

Thus, the yoke assembly 111 is environmentally protected with the cover 125 and the powder coating of the yoke. The cover 125 minimizes water intrusion into the cage and bearing.

The yoke assembly 111 provides a low friction swivel caster that is exceptionally resistant to rust.

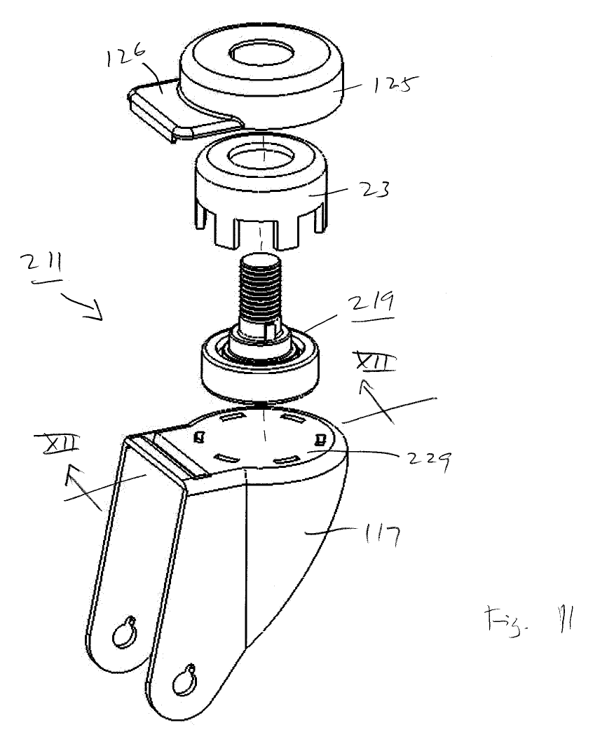

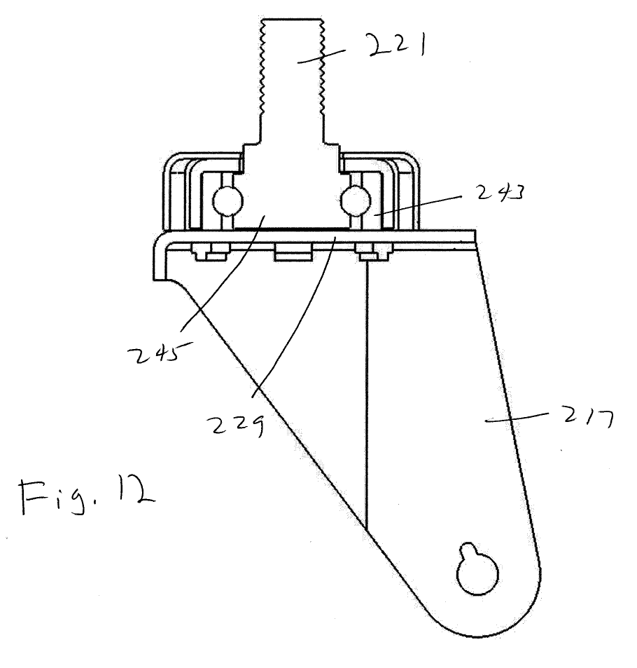

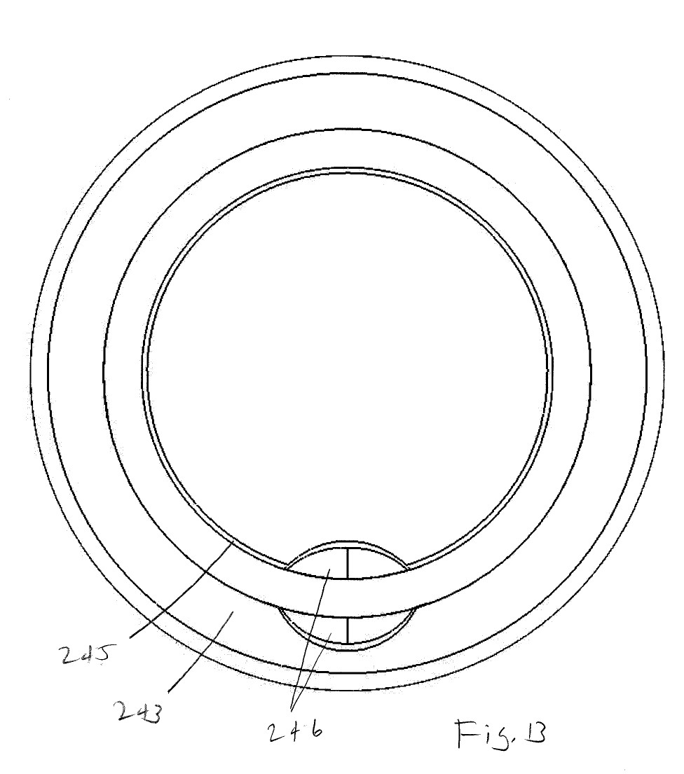

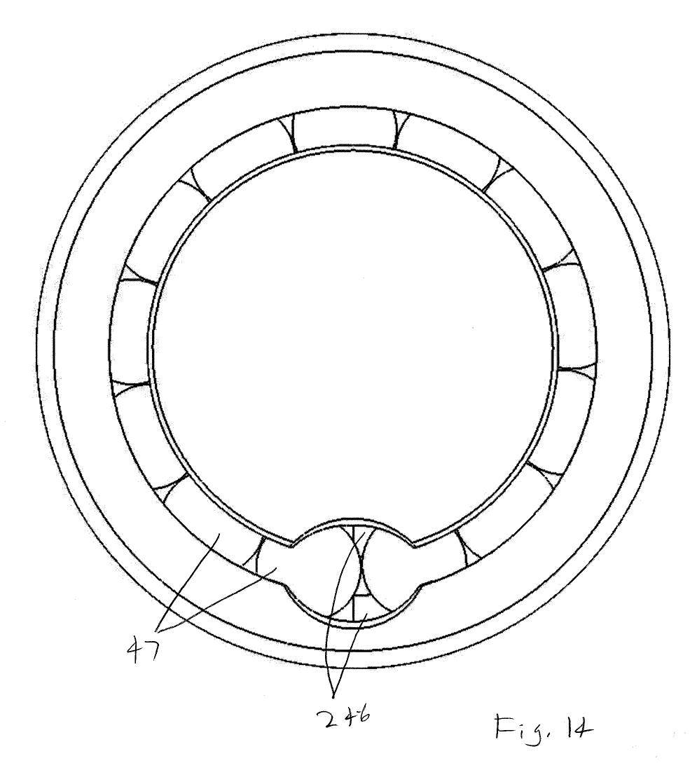

FIGS. 11-14 show another embodiment of the yoke assembly. The yoke assembly 211 of FIGS. 11-14 is substantially similar to the yoke assemblies 11 and 111 of FIGS. 1-7 and 8-10, with the exception of the cart yoke bearing 219.

The cart yoke bearing 219 has a single piece inner ring 245. The outer and inner rings 243, 245 have notches 246 in order to receive a maximum number of balls 47. To assemble the bearing, the inner ring 245 is located inside of the outer ring 243. Initially, the inner ring is not concentrically located so as to provide a large gap between itself and the outer ring. Balls are put into the enlarged gap between the two rings. As the number of balls in the bearing increases, the inner ring becomes concentrically located and the gap shrinks. The remaining balls are inserted through the aligned notches 246. As with the bearing 19, grease seals are not required with the cart yoke bearing 219.

The kingpin 221 can be integral with the inner ring 245. This allows the kingpin to be made from harder steel (as staking the kingpin to the inner ring is not required). In addition, the bottom of the kingpin can be flush with the bottom of the inner ring, wherein the king pin is wholly on the top side of the top plate. Thus, the yoke top plate 229 does not need an opening. The yoke top plate 229 is stronger by this arrangement. The yoke top plate 229 can be provided with a rib 119 (wherein the yoke can be powder coated due to the softer steel) or without a rib (wherein the yoke can be heat treated).

Thus, the present invention provides a yoke assembly with a bearing that can withstand the loads, thereby providing a low friction caster. Also, the yoke assembly minimizes rust. The yoke assembly provides a caster that can last the life of the shopping cart, which is typically five years.

The foregoing disclosure and showings made in the drawings are merely illustrative of the principles of this invention and are not to be interpreted in a limiting sense.

1. A swivel yoke assembly for supermarket material handling equipment, comprising:
a) a yoke having a top plate with an kingpin opening therethrough and with cage tab openings spaced about the kingpin opening, the yoke also having legs extending from the top plate, the legs being spaced apart from each other and being structured and arranged to receive a wheel and an axle;
b) a bearing having inner and outer races and balls located in the races, the inner and outer races covering at least 60% of the balls, the balls having spacing therebetween, the total spacing between the balls being less than one diameter of an individual one of the balls, the outer bearing on the top plate;
c) a kingpin located inside of the inner races of the bearing, the inner races of the bearing being secured to the kingpin by staking;
d) a cage covering the bearing, with the top plate interposed between the cage and the legs, the cage having tabs that are received by the tab openings in the top plate, the tabs forming double shoulder stakes on the leg side of the top plate.

2. The swivel yoke assembly of claim 1 wherein the top plate has a fore-and-aft axis, the tab openings being offset from the fore- and aft axis.

3. The swivel yoke assembly of claim 1 wherein the cage tabs are located around the circumference of the bearing, each tab having an inner shoulder on an inside of the tab and an outer shoulder on an outside of the tab.

4. The swivel yoke assembly of claim 1 wherein the bearing outer race is clamped between the cage and the top plate.

5. The swivel yoke assembly of claim 1 wherein the inner race is split into an upper portion and a lower portion.

6. The swivel yoke assembly of claim 1 wherein the inner and outer races each have a notch for receiving the balls into the inner and outer races.

7. The swivel yoke assembly of claim 1 wherein the yoke is heat treated.

8. The swivel yoke assembly of claim 1 further comprising a sleeve located around a circumference of the cage and a shield in an annulus between the cage and the kingpin, the sleeve and the shield protecting the bearing from the environment.

9. The swivel yoke assembly of claim 1 wherein:
a) the top plate has a fore-and-aft axis, the tab openings being offset from the fore- and aft axis;
b) the cage tabs are located around the circumference of the bearing, each tab having an inner shoulder on an inside of the tab and an outer shoulder on an outside of the tab;
c) the outer race is clamped between the cage and the top plate.

10. The swivel yoke assembly of claim 1 wherein the top plate has a fore-and-aft axis, the top plate further comprising a rib located on the fore- and aft axis.

11. The swivel yoke assembly of claim 1 wherein:
a) the cage tabs are located around the circumference of the bearing, each tab having an inner shoulder on an inside of the tab and an outer shoulder on an outside of the tab;
b) the outer race is clamped between the cage and the top plate.

12. The swivel yoke assembly of claim 11 further comprising a cover comprising a cup-shaped portion for fitting over the bearing and a flange that extends out from the cup-shaped portion, the flange covering the rib.

13. A swivel yoke assembly for supermarket material handling equipment, comprising:
a) a yoke having a top plate with cage tab openings spaced about the kingpin opening, the yoke also having legs extending from the top plate, the legs being spaced apart from each other and being structured and arranged to receive a wheel and an axle;
b) a bearing having inner and outer races and balls located in the races, the inner and outer races covering at least 60% of the balls, the balls having spacing therebetween, the total spacing between the balls being less than one diameter of an individual one of the balls, the outer bearing on the top plate;
c) a kingpin extending from the bearing;
d) a cage covering the bearing, with the top plate interposed between the cage and the legs, the cage having tabs that are received by the tab openings in the top plate, the tabs forming double shoulder stakes on the leg side of the top plate.

14. The swivel yoke assembly of claim 13 wherein the inner bearing is integral to the kingpin.

15. The swivel yoke assembly of claim 13 wherein the kingpin lies wholly on one side of the top plate.

16. The swivel yoke assembly of claim 13 wherein:
a) the inner bearing is integral to the kingpin;
b) the kingpin lies wholly on one side of the top plate.
